(19) United States
(12) Patent Application Publication
(10) Pub. No.: US 2024/0184417 A1
(43) Pub. Date: Jun. 6, 2024

(54) APPLICATION ICON DISPLAY METHOD AND APPARATUS, AND ELECTRONIC DEVICE

(71) Applicant: VIVO MOBILE COMMUNICATION CO., LTD., Dongguan (CN)

(72) Inventor: Ang LIU, Dongguan (CN)

(73) Assignee: VIVO MOBILE COMMUNICATION CO., LTD., Dongguan (CN)

(21) Appl. No.: 18/414,446

(22) Filed: Jan. 16, 2024

Related U.S. Application Data
(63) Continuation of application No. PCT/CN2022/105900, filed on Jul. 15, 2022.

(30) Foreign Application Priority Data
Jul. 20, 2021 (CN) 202110822161.9

(51) Int. Cl. G06F 3/04817; G06F 3/0482

(52) U.S. Cl. CPC G06F 3/04817; G06F 3/0482

(57) ABSTRACT

This application discloses an application icon display method and apparatus, and an electronic device. The method includes: receiving a first input when a first icon set is displayed in a first mode and a second icon set is displayed in a second mode; and in response to the first input, displaying a first target application icon in the second mode and displaying a second target application icon in the first mode, where the first icon set includes a plurality of first application icons, and the first target application icon is an icon in the first icon set; the second icon set includes a plurality of second application icons, and the second target application icon is an icon in the second icon set; and a display area of an application icon in the first mode is different from that in the second mode.

### CROSS-REFERENCE TO RELATED APPLICATIONS

This application is a continuation of International Application No. PCT/CN2022/105900, filed Jul. 15, 2022, which claims priority to Chinese Patent Application No. 202110822161.9, filed Jul. 20, 2021. The entire contents of each of the above-referenced applications are expressly incorporated herein by reference.

### TECHNICAL FIELD

This application relates to the technical field of intelligent terminals, and in particular, to an application icon display method and apparatus, and an electronic device.

### BACKGROUND

With the rapid development of smart watches, more and more functions can be realized. In addition to the basic function of indicating time, smart watches also have one or more functions such as reminding, navigation, positioning, calling, playing music, calibration, monitoring, and interaction. These functions are realized based on different applications.

On the display of the smart watch, icons of various applications are usually displayed in the form of lists or matrices, and users can arrange the icons of these applications at will according to habits or preferences thereof. However, due to the small display of the smart watch, the number of icons of applications that can be displayed on one screen is small, which is not conducive for users to quickly find the application required and user experience is poor.

### SUMMARY

Embodiments of this application aim to provide an application icon display method.

According to a first aspect, an embodiment of this application provides an application icon display method, and the method includes:
receiving a first input in a case that a first icon set is displayed in a first mode and a second icon set is displayed in a second mode; and
in response to the first input, displaying a first target application icon in the second mode and displaying a second target application icon in the first mode, where
the first icon set includes a plurality of first application icons, and the first target application icon is an icon in the first icon set; the second icon set includes a plurality of second application icons, and the second target application icon is an icon in the second icon set; and a display area of an application icon in the first mode is different from that in the second mode.

According to a second aspect, an embodiment of this application provides an application icon display apparatus, and the apparatus includes:
a receiving module, configured to receive a first input in a case that a first icon set is displayed in a first mode and a second icon set is displayed in a second mode; and
a response module, configured to: in response to the first input, display a first target application icon in the second mode and display a second target application icon in the first mode, where
the first icon set includes a plurality of first application icons, and the first target application icon is an icon in the first icon set; the second icon set includes a plurality of second application icons, and the second target application icon is an icon in the second icon set; and a display area of an application icon in the first mode is different from that in the second mode.

According to a third aspect, an embodiment of this application provides an electronic device. The electronic device includes a processor, a memory, and a program or an instruction stored in the memory and executable on the processor, where the program or the instruction is executed by the processor to implement steps of the method according to the first aspect.

According to a fourth aspect, an embodiment of this application provides a readable storage medium. The readable storage medium stores a program or an instruction, and when the program or the instruction is executed by a processor, steps of the method according to the first aspect are implemented.

According to a fifth aspect, an embodiment of this application provides a chip. The chip includes a processor and a communications interface, the communications interface is coupled to the processor, and the processor is configured to run a program or an instruction to implement the method according to the first aspect.

In the embodiments of this application, a first input is received in a case that a first icon set is displayed in a first mode, and a second icon set is displayed in a second mode; and in response to the first input, a first target application icon is displayed in the second mode, and a second target application icon is displayed in the first mode, where the first icon set includes a plurality of first application icons, and the first target application icon is an icon in the first icon set; the second icon set includes a plurality of second application icons, and the second target application icon is an icon in the second icon set; and a display area of an application icon in the first mode is different from that in the second mode. In this way, in response to the first input, the first target application icon is displayed in the second mode, and the second target application icon is displayed in the first mode, so that the display mode of the application icon can be switched without switching pages. The operation is more concise and convenient, and can help the user quickly find the application required.

### BRIEF DESCRIPTION OF DRAWINGS

FIG. 1 is a flowchart of an application icon display method according to an embodiment of this application;

FIG. 2 is a schematic diagram of a first display interface of an application icon display method according to Embodiment 1 of this application;

FIG. 3 is a schematic diagram of a second display interface of an application icon display method according to Embodiment 1 of this application;

FIG. 4 is a schematic diagram of a third display interface of an application icon display method according to Embodiment 1 of this application;

FIG. 5 is a schematic diagram of a first display interface of an application icon display method according to Embodiment 3 of this application;

FIG. 6 is a schematic diagram of a second display interface of an application icon display method according to Embodiment 3 of this application;

FIG. 7 is a schematic diagram of a fourth display interface of an application icon display method according to Embodiment 1 of this application;

FIG. 8 is a schematic diagram of a fifth display interface of an application icon display method according to Embodiment 1 of this application;

FIG. 9 is a schematic diagram of a sixth display interface of an application icon display method according to Embodiment 1 of this application;

FIG. 10 is a schematic diagram of a seventh display interface of an application icon display method according to Embodiment 1 of this application;

FIG. 11 is a schematic diagram of a display interface of an application icon display method according to Embodiment 2 of this application;

FIG. 12 is a schematic diagram of a structure of an application icon display apparatus according to an embodiment of this application;

FIG. 13 is a schematic diagram of a structure of an electronic device according to an embodiment of this application; and

FIG. 14 is a schematic diagram of a hardware structure of an electronic device according to an embodiment of this application.

### DETAILED DESCRIPTION

The following clearly describes technical solutions in embodiments of this application with reference to accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

In the specification and claims of this application, the terms “first”, “second”, and the like are intended to distinguish between similar objects but do not describe a specific order or sequence. It should be understood that, data used in such a way are interchangeable in proper circumstances, so that the embodiments of this application can be implemented in an order other than the order illustrated or described herein. Objects classified by “first”, “second”, and the like are usually of a same type, and the number of objects is not limited. For example, there may be one or more first objects. In addition, in the specification and the claims, “and/or” represents at least one of connected objects, and a character “/” generally represents an “or” relationship between associated objects.

The following describes in detail the icon processing method provided in the embodiments of this application through embodiments and application scenarios thereof with reference to the accompanying drawings.

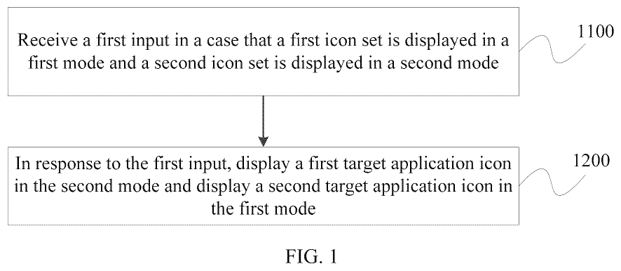

FIG. 1 is a schematic flowchart of an application icon display method according to an embodiment of this application. For example, the application icon display method in this embodiment of this application can be executed by an application icon display apparatus, and the application icon display apparatus can be arranged in an intelligent terminal, such as a smart watch.

As shown in FIG. 1, the application icon display method in this embodiment may include the following steps 1100 to 1200.

Step 1100. Receive a first input in a case that a first icon set is displayed in a first mode and a second icon set is displayed in a second mode.

The first icon set includes a plurality of first application icons, the second icon set includes a plurality of second application icons, and a display area of an application icon in the first mode is different from that in the second mode.

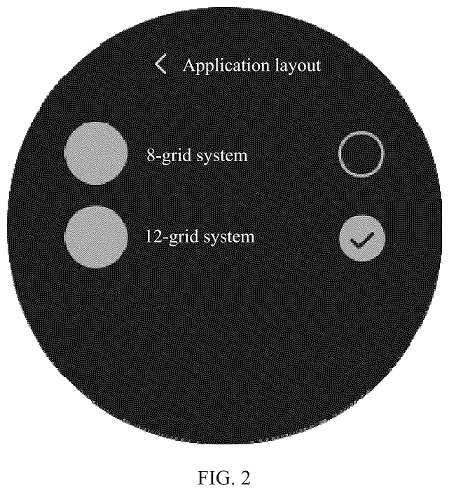

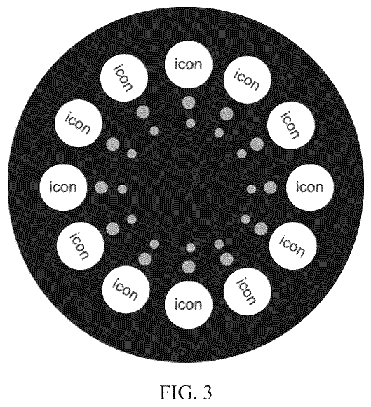

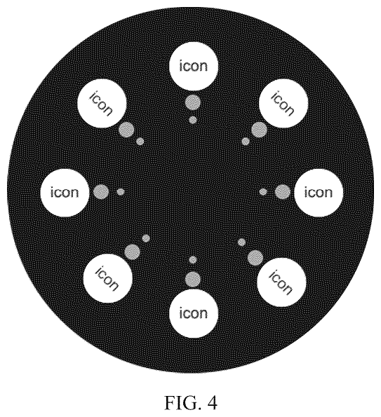

In an example, an application icon in the first icon set and an application icon in the second icon set are arranged and displayed in a circular layout. It should be noted that the number of icons arranged in the circular layout is preset by a user. As shown in FIG. 2, the user selects an application layout manner in settings, including 12-grid system and 8-grid system. If the user selects the 12-grid system, 12 icons are displayed in the annular layout, that is, the first icon set includes 12 first application icons, as shown in FIG. 3. If the user selects the 8-grid system, 8 icons are displayed in the annular layout, that is, the first icon set includes 8 first application icons, as shown in FIG. 4.

In an implementation, application icons in each icon set can be arranged clockwise from the position directly above. When the application icons are arranged in all icon positions in this icon set, a next icon set will appear, and so on. It can be understood that when the icon positions in this icon set are not fully arranged, a display interface of the next icon set will not appear.

In this way, the first icon set is displayed in the first mode, the second icon set is displayed in the second mode, and a display area of an application icon in the first mode is different from that in the second mode. This can increase the number of application icons displayed on the screen, so as to facilitate the user to quickly find the application required.

Step 1200. In response to the first input, display a first target application icon in the second mode and display a second target application icon in the first mode.

For example, before the first input is received, the first target application icon may be displayed as a complete application icon, and the second target application icon may be displayed as a point. After the first input is received, in response to the first input, the first target application icon is displayed as a point, and the second target application icon is displayed as a complete application icon.

The first target application icon is an icon in the first icon set, and the second target application icon is an icon in the second icon set. In some embodiments, the first target application icon may be a part of icons in the first icon set or all icons in the first icon set. For example, in response to the first input, one first target application icon in the first icon set is moved to the second icon set, and a display mode of the first target application icon is changed from the first mode to the second mode.

For example, in a case that the first input is a pinch input or a spread input at any position on an interface, the first target application icon is all icons in the first icon set. When the pinch input or the spread input is received, the first icon set is displayed in the second mode, and the second icon set is displayed in the first mode.

For example, before the first input is received, the first icon set is displayed on the outermost layer, and the second icon set is displayed on an inner layer. After the first input is received, a display position of the first icon set and a display position of the second icon set are switched, that is, the second icon set is displayed on the outermost layer, and the first icon set is displayed on the inner layer.

It can be understood that in order to avoid misoperation, a distance between the pinch input and the spread input can be set to be greater than a preset threshold, for example, the preset threshold can be 20 pixels, that is, when a distance between the pinch input and the spread input of two fingers of the user is greater than 20 pixels, the first icon set will be triggered to be displayed in the second mode, and the second icon set will be displayed in the first mode.

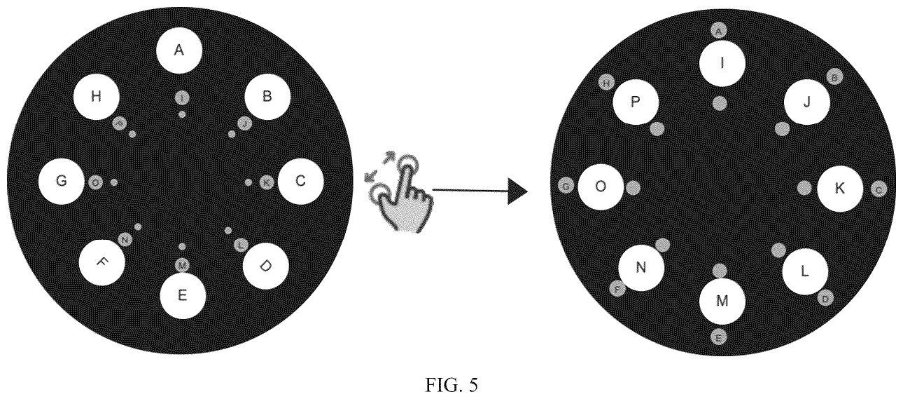

For example, as shown in FIG. 5, the user may perform a spread input at any position of the display interface with two fingers, and when a spread distance exceeds a preset threshold, the display position of the first icon set and the display position of the second icon set are exchanged.

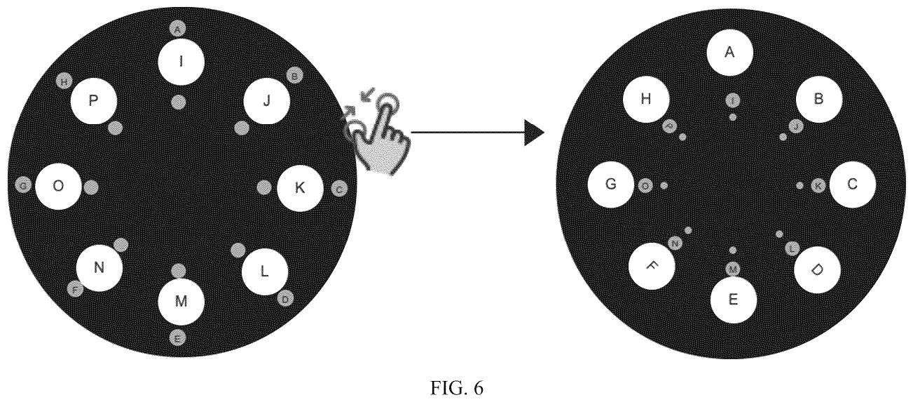

For another example, as shown in FIG. 6, the user may perform a pinch input at any position on the display interface with two fingers, and when a pinch distance exceeds a preset threshold, the display position of the second icon set and the display position of the first icon set are exchanged.

Thereby realizing conversion of the display mode of the icon set through a gesture of pinching or spreading without switching pages. The operation is more concise and convenient, and can further help the user quickly find the application required.

Further, after the step 1200, the application icon display apparatus may further be configured to: in response to the first input, switch the first target application icon from a first state to a second state, and switch the second target application icon from the second state to the first state.

Further, in a case that a second input to any second target application icon in the first state is received, an application interface corresponding to the any second target application icon is displayed; and in a case that a third input to any first target application icon in the second state is received, the third input is not responded.

Both the second input and the third input are used to indicate running the application.

For example, when the second input to the second target application icon in the first state is received, the application interface corresponding to the second target application icon is displayed, that is, the user can start an application corresponding to the second target application icon through the second input and use a function corresponding to the application. In a case that the third input to the first target application icon in the second state is received, the third input is not responded, that is, when the first target application icon is displayed as a point, the user cannot run a corresponding application through the third input, for example, tapping the first target application icon.

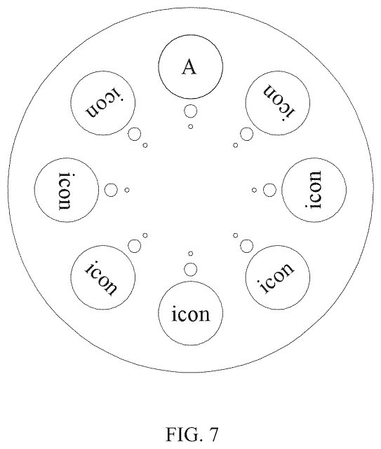

The 8-grid layout is used as an example. As shown in FIG. 7, a 3-layer annular layout is displayed in the display interface, which is referred to as a first icon set, a second icon set, and a third icon set sequentially from the outermost annular layout. For the first target application icon, the user may tap the icon to start a corresponding application and use a corresponding function. Display areas of application icons in the second icon set and the third icon set are gradually reduced, and the icons cannot be tapped to start corresponding applications.

In an embodiment, the user can also move the application icon to rearrange the layout. In some embodiments, after the receiving a first input, the method further includes: in response to the first input, moving the first target application icon from a first display position to a second display position, and moving the second target application icon from the second display position to a third display position.

In some embodiments, when the user touches and holds the first target application icon, the first target application icon can be enlarged to display, to prompt the user that the application icon is in an activated and enlarged state, and the first target application icon can be moved, deleted, and the like.

The first input is, for example, an input of dragging the first target application icon, and the display position of the first target application icon is adjusted by dragging the first target application icon. In response to the first input, the first target application icon is moved from a first display position to a second display position of the second target application icon, and the second target application icon is moved from the second display position to a third display position.

For example, the second target application icon refers to all second application icons in the second icon set; or the second target application icon refers to any second application icon in the second icon set. A direction of moving the first target application icon and the second target application icon may be clockwise or counterclockwise.

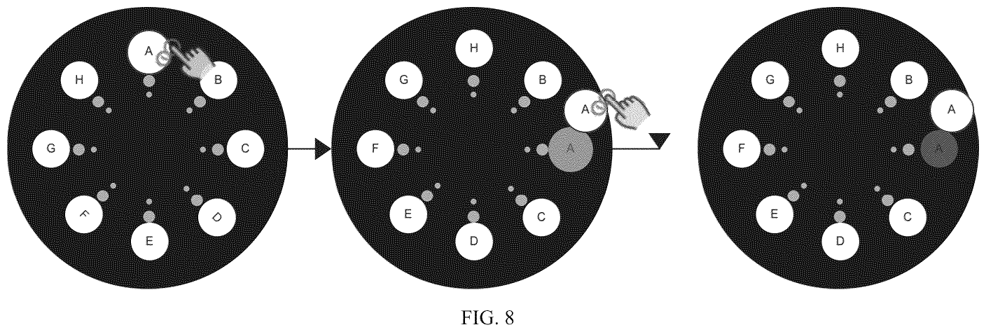

In an example, as shown in FIG. 8, the user touches and holds a first target application icon A in the first icon set, so that the first target application icon A enters the activated and enlarged state, drags the first target application icon A to the middle of a first target application icon B and a first target application icon C that are in the first icon set, and determines a display position of a second target application icon C in a clockwise direction of the first target application icon A as the target position. Then, after positions of all second target application icons in the clockwise direction of the first target application icon A are sequentially moved, the first target application icon A is adjusted to an original position of the second target application icon C, and adjustment is completed after the user releases the finger.

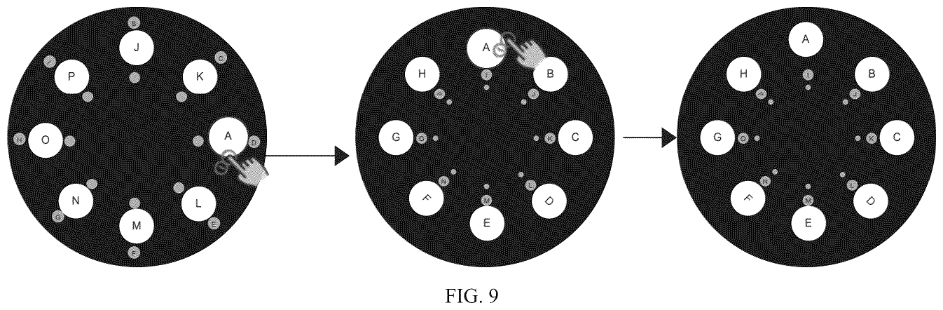

In another example, as shown in FIG. 9, the user touches and holds the first target application icon A, so that the first target application icon A enters the activated and enlarged state, and drags the first target application icon A into the first icon set. In this case, the first icon set is enlarged to display, and the first target application icon A is dragged to the middle of second target application icons H and B. In this case, a display position of the second target application icon B in the clockwise direction of the first target application icon A is determined as the target position, and then positions of all second target application icons in the clockwise direction of the first target application icon A are sequentially moved to make up for a vacant icon display position, and the first target application icon A is adjusted to an original position of the second target application icon B. Adjustment is completed after the user releases the finger.

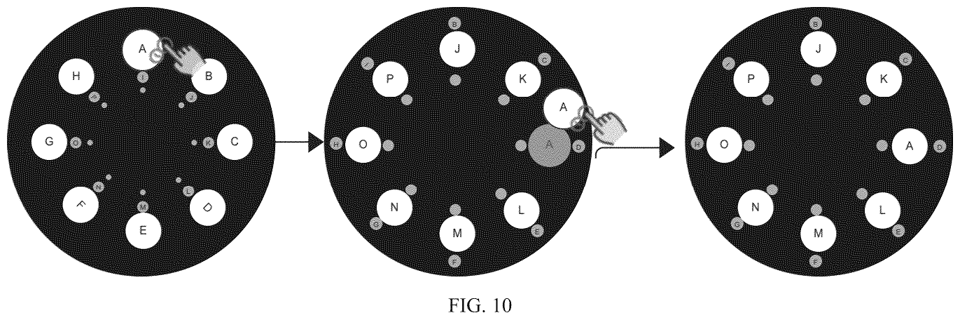

In another example, as shown in FIG. 10, the user touches and holds the first target application icon A in the first icon set, so that the first target application icon A enters the activated and enlarged state, and drags the first target application icon A into the second icon set. In this case, the second icon set is enlarged to display, and the first target application icon A is dragged to the middle of a second target application icon K and a second target application icon L. In this case, a display position of the second target application icon L in the clockwise direction of the first target application icon A is determined as the target position, and then positions of all second target application icons in the clockwise direction of the first target application icon A are sequentially moved to make up for a vacant icon display position, and the first target application icon A is adjusted to an original position of the second target application icon L. Adjustment is completed after the user releases the finger.

Further, in some feasible embodiments, in addition to sequentially moving display positions of remaining second target application icons, the display position of the first target application icon and the display position of the second target application icon can be exchanged, that is, the first display position is the same as the third display position. In this case, the number of the first target application icons is the same as the number of the second target application icons.

In this embodiment of this application, the application icon can also be deleted. The method further includes:
receiving a fourth input for moving a third target application icon to a central area of an interface, and in response to the fourth input, deleting the third target application icon.

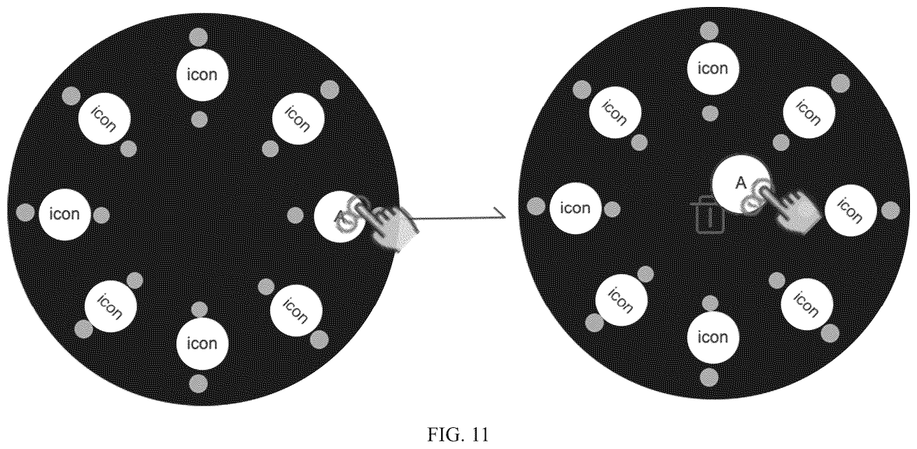

In this embodiment, the user can touch and hold the third target application icon to enable the third target application icon to enter the activated and enlarged state. As shown in FIG. 11, the third target application icon can be deleted by dragging the third target application icon to the central area of the display interface and releasing the finger. In some embodiments, when the third target application icon is dragged to the central area of the display interface, a garbage can logo can be displayed in the central area to prompt the user that the current operation is to delete the icon.

According to the technical solutions of this embodiment of this application, the fourth input for the user to drag the third target application icon to the center of the display interface is received, and in response to the fourth input, the third target application icon is deleted. Characteristics of the display interface are fully utilized, and a deletion function is set in the center of the display interface, which is convenient for the user to realize the function of deleting the icon by simply dragging the icon in the same display interface.

It should be noted that, the application icon display method provided in the embodiments of this application may be performed by an application icon display apparatus, or a control module, in the application icon display apparatus, configured to perform the application icon display method. In the embodiments of this application, an example in which the application icon display apparatus performs the application icon display method is used to describe the application icon display apparatus provided in the embodiments of this application.

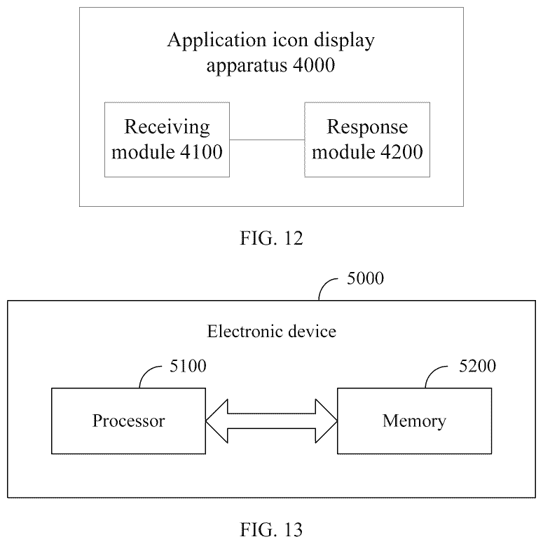

FIG. 12 is a schematic diagram of a structure of an application icon display apparatus according to an embodiment of this application. As shown in FIG. 12, the application icon display apparatus 4000 in this embodiment of this application may include a receiving module 4100 and a response module 4200.

The receiving module 4100 is configured to receive a first input in a case that a first icon set is displayed in a first mode and a second icon set is displayed in a second mode.

The response module 4200 is configured to: in response to the first input, display a first target application icon in the second mode and display a second target application icon in the first mode.

The first icon set includes a plurality of first application icons, and the first target application icon is an icon in the first icon set; the second icon set includes a plurality of second application icons, and the second target application icon is an icon in the second icon set; and a display area of an application icon in the first mode is different from that in the second mode.

In an embodiment, the response module 4200 is further configured to: in response to the first input, switch the first target application icon from a first state to a second state, and switch the second target application icon from the second state to the first state; in a case that a second input to a second target application icon in the first state is received, display an application interface corresponding to the second target application icon; and in a case that a third input to any first target application icon in the second state is received, not respond to the third input.

In an embodiment, the response module 4200 is further configured to: in response to the first input, move the first target application icon from a first display position to a second display position, and move the second target application icon from the second display position to a third display position.

In an embodiment, the first display position is the same as the third display position.

In an embodiment, in a case that the first input is a pinch input or a spread input, the first target application icon is all icons in the first icon set.

In an embodiment, the receiving module 4100 is further configured to: receive a fourth input for moving a third target application icon to a central area of an interface; and the response module 4200 is further configured to: in response to the second input, delete the third target application icon.

According to the application icon display apparatus in this embodiment, the receiving module is configured to receive a first input in a case that a first icon set is displayed in a first mode and a second icon set is displayed in a second mode; and the response module is configured to: in response to the first input, display the first target application icon in the second mode and display the second target application icon in the first mode, where the first icon set includes a plurality of first application icons, and the first target application icon is an icon in the first icon set; the second icon set includes a plurality of second application icons, and the second target application icon is an icon in the second icon set; and a display area of an application icon in the first mode is different from that in the second mode. In this way, in response to the first input, the first target application icon is displayed in the second mode, and the second target application icon is displayed in the first mode, so that the display mode of the application icon can be switched without switching pages. The operation is more concise and convenient, and can help the user quickly find the application required.

The application icon display apparatus in this embodiment of this application may be an apparatus, or may be a component, an integrated circuit, or a chip in a terminal. The apparatus may be a mobile electronic device. For example, the mobile electronic device may be a mobile phone, a tablet computer, a notebook computer, a palmtop computer, an in-vehicle electronic device, a wearable device, an ultra-mobile personal computer (UMPC), a netbook, or a personal digital assistant (PDA). This is not specifically limited in this embodiment of this application.

The application icon display apparatus in this embodiment of this application may be an apparatus with an operating system. The operating system may be an Android operating system, an iOS operating system, or another possible operating system. This is not specifically limited in this embodiment of this application.

The application icon display apparatus provided in this embodiment of this application can implement the processes implemented in the method embodiments in FIG. 1 to FIG. 11. To avoid repetition, details are not described herein again.

As shown in FIG. 13, an embodiment of this application further provides an electronic device 5000, including a processor 5100, a memory 5200, and a program or an instruction stored in the memory 5200 and executable on the processor 5100. When the program or the instruction is executed by the processor 5100, the processes of the foregoing application icon display method embodiment are implemented and a same technical effect can be achieved. To avoid repetition, details are not described herein again.

It should be noted that the electronic device in the embodiments of this application includes the foregoing mobile electronic device.

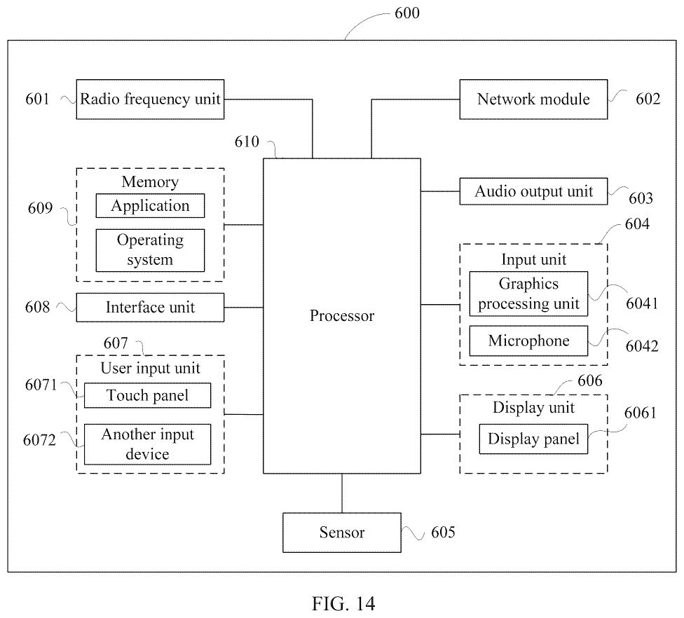

FIG. 14 is a schematic diagram of a hardware structure of an electronic device according to an embodiment of this application.

The electronic device 600 includes but is not limited to components such as a radio frequency unit 601, a network module 602, an audio output unit 603, an input unit 604, a sensor 605, a display unit 606, a user input unit 607, an interface unit 608, a memory 609, and a processor 610.

A person skilled in the art can understand that the electronic device 600 may further include a power supply (such as a battery) that supplies power to each component. The power supply may be logically connected to the processor 610 by using a power supply management system, to implement functions such as charging and discharging management, and power consumption management by using the power supply management system. The structure of the electronic device shown in FIG. 14 does not constitute a limitation on the electronic device. The electronic device may include components more or fewer than those shown in the diagram, a combination of some components, or different component arrangements. Details are not described herein.

The electronic device in this embodiment of this application may be used to perform the technical solutions of the foregoing method embodiments. Implementation principles and technical effects thereof are similar to the method embodiments. Details are not described herein again.

It should be understood that, in the embodiments of this application, the input unit 604 may include a Graphics Processing Unit (GPU) 6041 and a microphone 6042, and the graphics processing unit 6041 processes image data of a still picture or video obtained by an image capture apparatus (such as a camera) in a video capture mode or an image capture mode. The display unit 606 may include a display panel 6061. In some embodiments, the display panel 6061 may be configured in a form such as a liquid crystal display or an organic light-emitting diode. The user input unit 607 includes a touch panel 6071 and another input device 6072. The touch panel 6071 is also referred to as a touchscreen. The touch panel 6071 may include two parts: a touch detection apparatus and a touch controller. The another input device 6072 may include but is not limited to a physical keyboard, a functional button (such as a volume control button or a power on/off button), a trackball, a mouse, and a joystick. Details are not described herein. The memory 609 may be configured to store a software program and various data, including but not limited to an application and an operating system. An application processor and a modem processor may be integrated into the processor 610, the application processor mainly processes an operating system, a user interface, an application, and the like, and the modem processor mainly processes wireless communication. It can be understood that the modem processor may not be integrated into the processor 610.

An embodiment of this application further provides a readable storage medium, where the readable storage medium stores a program or an instruction, and when the program or the instruction is executed by a processor, the processes of the foregoing application icon display method embodiment are implemented, and a same technical effect can be achieved. To avoid repetition, details are not described herein again.

The processor is a processor in the electronic device in the foregoing embodiment. The readable storage medium includes a computer-readable storage medium, such as a computer Read-Only Memory (ROM), a Random Access Memory (RAM), a magnetic disk, or an optical disc.

An embodiment of this application also provides a chip, where the chip includes a processor and a communications interface, and the communications interface is coupled to the processor. The processor is configured to run a program or an instruction to implement the processes of the foregoing application icon display method embodiment, and a same technical effect can be achieved. To avoid repetition, details are not described herein again.

It should be understood that the chip mentioned in this embodiment of this application may also be referred to as a system-level chip, a system chip, a chip system, or an on-chip system chip.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to such process, method, article, or apparatus. In absence of more constraints, an element preceded by “includes a . . . ” does not preclude the existence of other identical elements in the process, method, article, or apparatus that includes the element. In addition, it should be noted that the scope of the method and the apparatus in the embodiments of this application is not limited to performing functions in an illustrated or discussed sequence, and may further include performing functions in a basically simultaneous manner or in a reverse sequence according to the functions concerned. For example, the described method may be performed in an order different from that described, and the steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. Based on such an understanding, the technical solutions of this application essentially or the part contributing to the prior art may be implemented in a form of a computer software product. The computer software product is stored in a storage medium (such as a ROM/RAM, a hard disk, or an optical disc), and includes several instructions for instructing a terminal (which may be a mobile phone, a computer, a server, a network device, or the like) to perform the methods described in the embodiments of this application.

The embodiments of this application are described above with reference to the accompanying drawings, but this application is not limited to the above implementations, and the above implementations are only illustrative and not restrictive. Under the enlightenment of this application, those of ordinary skill in the art can make many forms without departing from the purpose of this application and the protection scope of the claims, all of which fall within the protection of this application.

1. A method for application icon display, comprising:
receiving a first input when a first icon set is displayed in a first mode and a second icon set is displayed in a second mode; and
in response to the first input, displaying a first target application icon in the second mode and displaying a second target application icon in the first mode,
wherein the first icon set comprises a plurality of first application icons, and the first target application icon is an icon in the first icon set; the second icon set comprises a plurality of second application icons, and the second target application icon is an icon in the second icon set; and a display area of an application icon in the first mode is different from that in the second mode.

2. The method according to claim 1, wherein after receiving the first input, the method further comprises:
in response to the first input, switching the first target application icon from a first state to a second state, and switching the second target application icon from the second state to the first state;
when a second input to any second target application icon in the first state is received, displaying an application interface corresponding to the any second target application icon; and
when a third input to any first target application icon in the second state is received, not responding to the third input.

3. The method according to claim 1, wherein after receiving the first input, the method further comprises:
in response to the first input, moving the first target application icon from a first display position to a second display position, and moving the second target application icon from the second display position to a third display position.

4. The method according to claim 3, wherein the first display position is the same as the third display position.

5. The method according to claim 1, wherein when the first input is a pinch input or a spread input, the first target application icon is all icons in the first icon set.

6. The method according to claim 1, further comprising:
receiving a fourth input for moving a third target application icon to a central area of an interface; and
in response to the fourth input, deleting the third target application icon.

7. An electronic device, comprising: a memory storing a computer program; and a processor coupled to the memory and configured to execute the computer program to perform operations comprising:
receiving a first input when a first icon set is displayed in a first mode and a second icon set is displayed in a second mode; and
in response to the first input, displaying a first target application icon in the second mode and displaying a second target application icon in the first mode,
wherein the first icon set comprises a plurality of first application icons, and the first target application icon is an icon in the first icon set; the second icon set comprises a plurality of second application icons, and the second target application icon is an icon in the second icon set; and a display area of an application icon in the first mode is different from that in the second mode.

8. The electronic device according to claim 7, wherein after receiving the first input, the operations further comprise:
in response to the first input, switching the first target application icon from a first state to a second state, and switching the second target application icon from the second state to the first state;
when a second input to any second target application icon in the first state is received, displaying an application interface corresponding to the any second target application icon; and
when a third input to any first target application icon in the second state is received, not responding to the third input.

9. The electronic device according to claim 7, wherein after receiving the first input, the operations further comprise:
in response to the first input, moving the first target application icon from a first display position to a second display position, and moving the second target application icon from the second display position to a third display position.

10. The electronic device according to claim 9, wherein the first display position is the same as the third display position.

11. The electronic device according to claim 7, wherein when the first input is a pinch input or a spread input, the first target application icon is all icons in the first icon set.

12. The electronic device according to claim 7, wherein the operations further comprise:
receiving a fourth input for moving a third target application icon to a central area of an interface; and
in response to the fourth input, deleting the third target application icon.

13. A non-transitory computer-readable storage medium, storing a computer program, when the computer program is executed by a processor, causes the processor to perform operations comprising:
receiving a first input when a first icon set is displayed in a first mode and a second icon set is displayed in a second mode; and
in response to the first input, displaying a first target application icon in the second mode and displaying a second target application icon in the first mode,
wherein the first icon set comprises a plurality of first application icons, and the first target application icon is an icon in the first icon set; the second icon set comprises a plurality of second application icons, and the second target application icon is an icon in the second icon set; and a display area of an application icon in the first mode is different from that in the second mode.

14. The non-transitory computer-readable storage medium according to claim 13, wherein after receiving the first input, the operations further comprise:
in response to the first input, switching the first target application icon from a first state to a second state, and switching the second target application icon from the second state to the first state;
when a second input to any second target application icon in the first state is received, displaying an application interface corresponding to the any second target application icon; and
when a third input to any first target application icon in the second state is received, not responding to the third input.

15. The non-transitory computer-readable storage medium according to claim 13, wherein after receiving the first input, the operations further comprise:
in response to the first input, moving the first target application icon from a first display position to a second display position, and moving the second target application icon from the second display position to a third display position.

16. The non-transitory computer-readable storage medium according to claim 15, wherein the first display position is the same as the third display position.

17. The non-transitory computer-readable storage medium according to claim 13, wherein when the first input is a pinch input or a spread input, the first target application icon is all icons in the first icon set.

18. The non-transitory computer-readable storage medium according to claim 13, wherein the operations further comprise:
receiving a fourth input for moving a third target application icon to a central area of an interface; and
in response to the fourth input, deleting the third target application icon.
